(19) United States
(12) Patent Application Publication
(10) Pub. No.: US 2013/0099089 A1
(43) Pub. Date: Apr. 25, 2013

(54) MOULD ASSEMBLY WITH A HEATING DEVICE

(71) Applicants: YU-YEN CHANG, Kunshan City (CN); Chung-Nan Liu, Douliu City (TW)

(72) Inventors: YU-YEN CHANG, Kunshan City (CN); Chung-Nan Liu, Douliu City (TW)

(73) Assignees: Kunshan Yurong Electronics Co., Ltd., Kunshan City (CN); Chung-Nan Liu, Douliu City (TW)

(21) Appl. No.: 13/608,170

(22) Filed: Sep. 10, 2012

(30) Foreign Application Priority Data
Oct. 19, 2011 (TW) 100137826

(51) Int. Cl. B29C 33/02

(52) U.S. Cl. 249/78

(57) ABSTRACT

A mould assembly with a heating device comprises: an upper mould with an upper joint surface, a lower mould, two conductive plates and two conductive wires. The lower mould includes a conductive layer, a lower joint surface which is formed on the conductive layer and faces the upper joint surface, an insulating surface which is formed on the conductive layer and faces in an opposite direction from the lower joint surface, an insulating formed on the insulating surface. The two conductive plates are disposed on the conductive layer of the lower mould. The two conductive wires are connected to the conductive plates and each have a resistivity lower than a resistivity of the conductive layer. The mould assembly with a heating device is low cost and capable of making the temperature distribution on the surface of the mould assembly more uniform.

### BACKGROUND OF THE INVENTION

1. Field of the Invention

The present invention relates to a mould assembly, and more particularly to a mould assembly with a heating device used in thermoplastic or thermosetting process.

2. Description of the Prior Art

Inside the mould or on the mould parting surface of conventional mould assembly is normally provided a high-frequency induction heat conductive coil in order to make the mould assembly have a heating function. The heat conductive coil is connected to a high-frequency power supply system, so that the heat conductive coil can heat the mould assembly from a room temperature to an operating temperature, and the heating area is restricted within the contacting surface between the mould assembly and the material to be molded.

However, the high-frequency heat conductive oil is not suitable for use in the mould assembly where the mould insert has a complex shape, and the high-frequency heat conductive coil further has the problems of uneven heating, namely, uneven distribution of temperature on the mould surface, unstable induced current, long heating time, and high power consumption.

The present invention has arisen to mitigate and/or obviate the afore-described disadvantages.

### SUMMARY OF THE INVENTION

The primary object of the present invention is to provide a mould assembly with a heating device which is low cost and capable of making the temperature distribution on the surface of the mould assembly more uniform.

To achieve the above object, a mould assembly with a heating device in accordance with a first embodiment of the present invention comprises: an upper mould with an upper joint surface, a lower mould, two conductive plates and two conductive wires. The lower mould includes a conductive layer, a lower joint surface which is formed on the conductive layer and faces the upper joint surface, an insulating surface which is formed on the conductive layer and faces in an opposite direction from the lower joint surface, an insulating formed on the insulating surface. The two conductive plates are disposed on the conductive layer of the lower mould. The two conductive wires are connected to the conductive plates and each have a resistivity lower than a resistivity of the conductive layer.

To achieve the above object, a mould assembly with a heating device in accordance with a second embodiment of the present invention comprises: an upper mould, a lower mould, two conductive plates and two conductive wires. The upper mould includes a conductive layer, an upper joint surface formed on the conductive layer, an insulating surface which is formed on the conductive layer and faces in an opposite direction from the upper joint surface, and an insulating layer formed on the insulating surface. The lower mould includes a lower joint surface facing the upper joint surface. The two conductive plates are disposed on the conductive layer of the upper mould. The two conductive wires are connected to the conductive plates and have a resistivity lower than a resistivity of the conductive layer.

To achieve the above object, a mould assembly with a heating device in accordance with a third embodiment of the present invention comprises: an upper mould, a lower mould, two upper conductive plates, two upper conductive wires, two lower conductive plates, and two lower conductive wires. The upper mould includes an upper conductive layer, an upper joint surface formed on the upper conductive layer, an upper insulating surface which is formed on the upper conductive layer and faces in an opposite direction from the upper joint surface, and an upper insulating layer formed on the upper insulating surface. The lower mould includes a lower conductive layer, a lower joint surface formed on the lower conductive layer, a lower insulating surface which is formed on the lower conductive layer and faces in an opposite direction from the lower joint surface, and a lower insulating layer formed on the lower insulating surface. The two upper conductive plates are disposed on the upper conductive layer of the upper mould. The two upper conductive wires are connected to the upper conductive plates and have a resistivity lower than a resistivity of the upper conductive layer. The two lower conductive plates are disposed on the lower conductive layer of the lower mould, and the two lower conductive wires are connected to the lower conductive plates and have a resistivity lower than a resistivity of the lower conductive layer.

### BRIEF DESCRIPTION OF THE DRAWINGS

FIG. 1 is a cross sectional view of a mould assembly with a heating device in accordance with a first embodiment of the present invention;

FIG. 2 is an operational view of the mould assembly with a heating device in accordance with the first embodiment of the present invention;

FIG. 3 shows a heating device in accordance with one aspect of the first embodiment of the present invention;

FIG. 4 shows a heating device in accordance with another aspect of the first embodiment of the present invention;

FIG. 5 is a cross sectional view of a mould assembly with a heating device in accordance with a second embodiment of the present invention;

FIG. 6 is an operational view of the mould assembly with a heating device in accordance with the second embodiment of the present invention;

FIG. 7 shows a heating device in accordance with one aspect of the second embodiment of the present invention;

FIG. 8 shows a heating device in accordance with another aspect of the second embodiment of the present invention;

FIG. 9 is a cross sectional view of a mould assembly with a heating device in accordance with a third embodiment of the present invention;

FIG. 10 shows a heating device in accordance with one aspect of the third embodiment of the present invention; and

FIG. 11 shows a heating device in accordance with another aspect of the third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

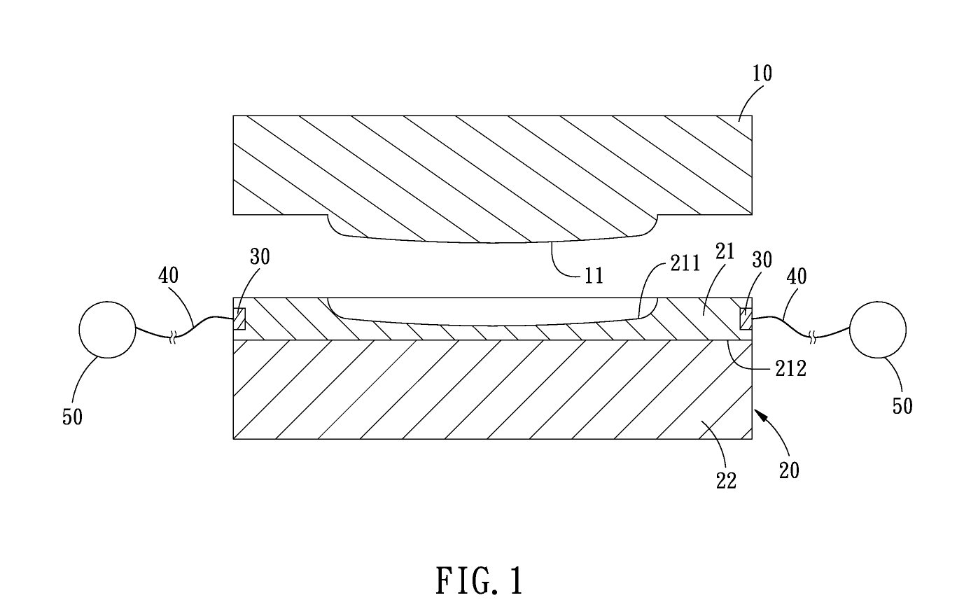

Referring to FIG. 1, a mould assembly with a heating device in accordance with a first embodiment of the present invention comprises: an upper mould 10, a lower mould 20, two conductive plates 30 and two conductive wires 40.

The upper mould 10 includes an upper joint surface 11.

The lower mould 20 includes a steel (or aluminum)-made conductive layer 21, a lower joint surface 211 which is formed on the conductive layer 21 and faces the upper joint surface 11, an insulating surface 212 which is formed on the conductive layer 21 and faces in an opposite direction from the lower joint surface 211, and an insulating layer 22 formed on the insulating surface 212. The insulating layer 22 can be formed by being subjected to electrical insulation treatment and the conductive layer 21 can be formed by being subjected to anodized treatment.

The two conductive plates 30 are disposed at both sides of the conductive layer 21 of the lower mould 20.

The two conductive wires 40 are connected to the conductive plates 30 and have a resistivity lower than the resistivity of the conductive layer 21. Each of the conductive wires 40 is made of copper (or coated with silver or gold) and connected to a power supply 50.

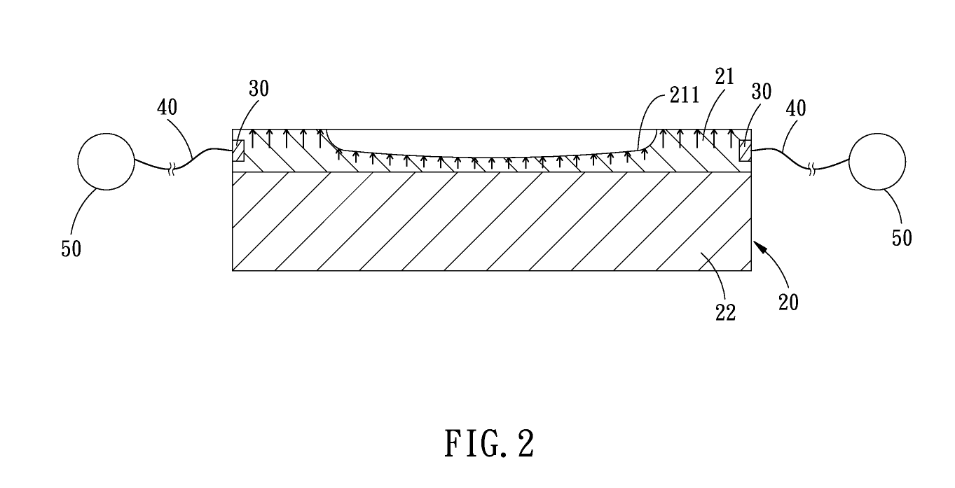

Referring then to FIG. 2, when an AC current from the power supplies 50 is transmitted to the conductive layer 21 of the lower mould 20 via the conductive wires 40 and the conductive plates 30, the AC current will be gathered together in the lower joint surface 211 of the conductive layer 21, and consequently, the lower joint surface 211 of the lower mould 20 will be heated up to an operating temperature from a room temperature, so that the heating area is restricted within the lower joint surface 211. The present invention simply consists of the upper and lower moulds 10, 20, and two conductive plates 30 and two conductive wires 40, and also has the heating function; therefore, the cost can be reduced. On top of that, since the electric current is gathered together on the lower joint surface 211 of the lower mould 20, the outer surface of the mould assembly of the present invention can be uniformly heated no matter how the shape of the lower joint surface 211 changes.

It is to be noted that the present invention is capable of controlling the frequency of the AC current supplied from the power supplies 50. The higher the frequency of the AC current is, the smaller the thickness of the lower joint surface 211 of the lower mould 20 is, the faster the temperature will rise.

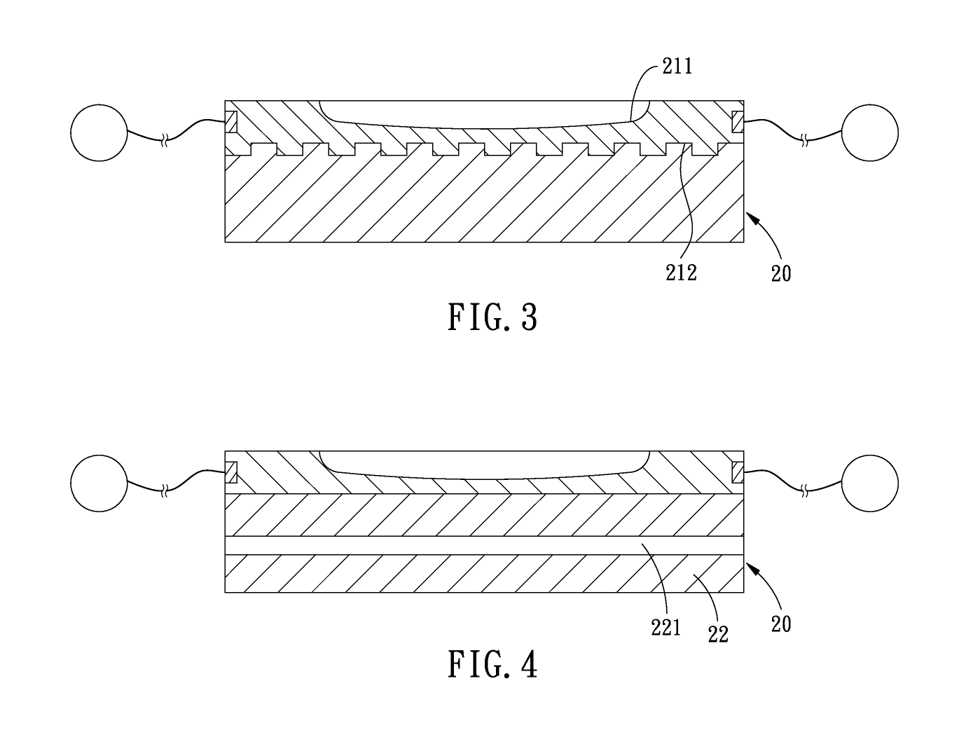

Referring then to FIG. 3, a heating device in accordance with one aspect of the first embodiment of the present invention is shown, wherein the insulating surface 212 of the lower mould 20 is designed to be larger than the lower joint surface 211. For example, the insulating surface 212 is formed with a plurality of concaves and convexes to increase the area of the insulating surface 212. Since the insulating surface 212 of the lower mould 20 is larger than the lower joint surface 211, the resistance of the insulating surface 212 is also larger than that of the lower joint surface 211. Therefore, the electric current will be collected in the lower joint surface 211 due to the fact that electric current tends to flow to low resistance area, so that the heating time required to heat the lower joint surface 211 from a room temperature to an operating temperature is reduced.

Referring to FIG. 4, a heating device in accordance with another aspect of the first embodiment of the present invention is shown, in the insulating layer 22 of the lower mould 20 is provided a cooling passage 221 in which is filled coolant, to cool off the lower mould 20, so as to extend the service life of the mould assembly.

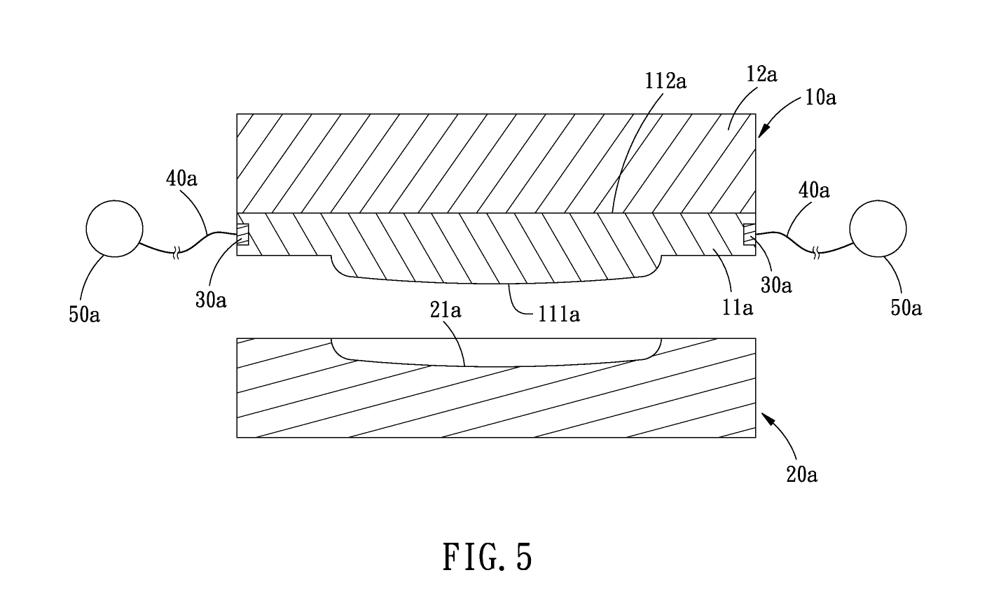

Referring to FIG. 5, a mould assembly with a heating device in accordance with a second embodiment of the present invention also comprises: an upper mould 10a, a lower mould 20a, two conductive plates 30a and two conductive wires 40a, and is similar to the first embodiment, except that:

The upper mould 10a includes a steel (or aluminum)-made conductive layer 11a, an upper joint surface 111a which is formed on the conductive layer 11a, an insulating surface 112a which is formed on the conductive layer 11a and faces in an opposite direction from the upper joint surface 111a, and an insulating layer 12a formed on the insulating surface 112a. The insulating layer 12a can be formed by being subjected to electrical insulation treatment and the conductive layer 11a can be formed by being subjected to anodized treatment.

The lower mould 20a includes a lower joint surface 21a facing the upper joint surface 111a.

The two conductive plates 30a are disposed at both sides of the conductive layer 11a of the upper mould 10a.

The two conductive wires 40a are connected to the conductive plates 30a and have a resistivity lower than the resistivity of the conductive layer 11a. Each of the conductive wires 40a is made of copper (or coated with silver or gold) and connected to a power supply 50a.

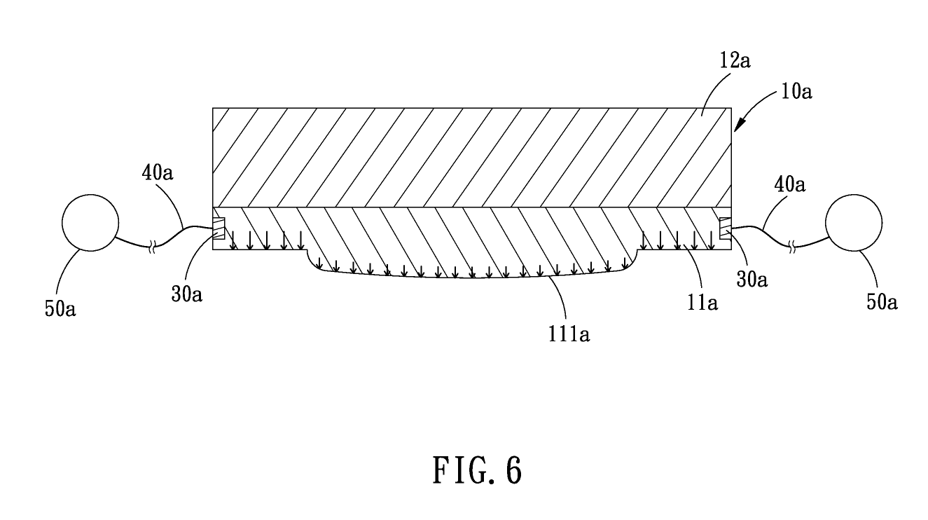

Referring then to FIG. 6, when an AC current from the power supplies 50a is transmitted to the conductive layer 11a of the upper mould 10a via the conductive wires 40a and the conductive plates 30a, the AC current will be gathered together in the upper joint surface 111a of the conductive layer 11a, and consequently, the upper joint surface 111a of the upper mould 10a will be heated up to an operating temperature from a room temperature, so that the heating area is restricted within the upper joint surface 111a.

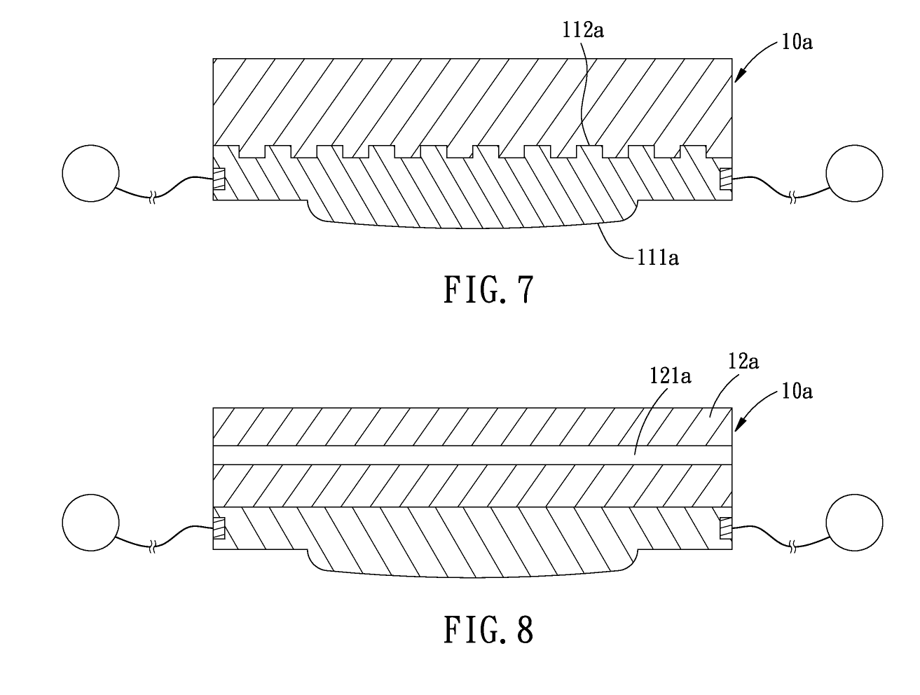

Referring to FIG. 7, a heating device in accordance with one aspect of the second embodiment of the present invention is shown, which is also capable of reducing the time required to heat the upper joint surface 111a from a room temperature to an operating temperature, namely, the insulating surface 112a of the upper mould 10a is also designed to be larger than the upper joint surface 111a in the same way as the first embodiment, so further description is omitted.

Referring to FIG. 8, a heating device in accordance with another aspect of the second embodiment of the present invention is shown, in the insulating layer 12a of the upper mould 10a is provided a cooling passage 121a in which is filled coolant, to cool off the upper mould 10a, so as to extend the service life of the mould assembly.

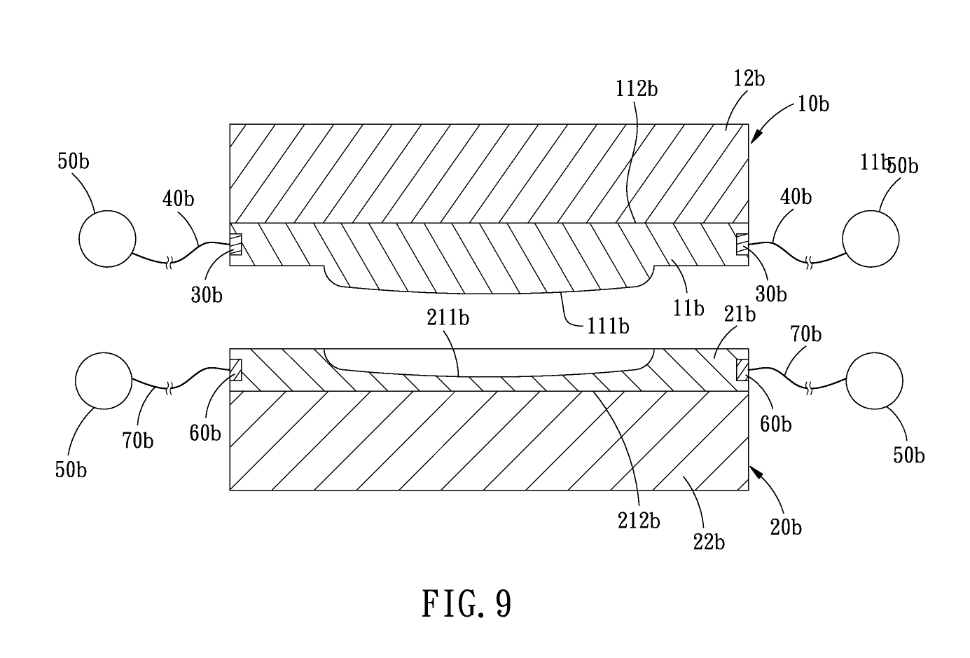

Referring to FIG. 9, a mould assembly with a heating device in accordance with a third embodiment of the present invention also comprises: an upper mould 10b, a lower mould 20b, two upper conductive plates 30b and two upper conductive wires 40b, two lower conductive plates 60b, and two lower conductive wires 70b. The mould assembly with a heating device in accordance with the third embodiment is similar to the first embodiment, except that:

The upper mould 10a includes a steel (or aluminum)-made upper conductive layer 11b, an upper joint surface 111b which is formed on the upper conductive layer 11b, an upper insulating surface 112b which is formed on the upper conductive layer 11b and faces in an opposite direction from the upper joint surface 111b, and an upper insulating layer 12b formed on the upper insulating surface 112b. The upper insulating layer 12b can be formed by being subjected to electrical insulation treatment and the upper conductive layer 11b can be formed by being subjected to anodized treatment.

The lower mould 20b includes a steel (or aluminum)-made lower conductive layer 21b, a lower joint surface 211b which is formed on the lower conductive layer 21b, a lower insulating surface 212b which is formed on the lower conductive layer 21b and faces in an opposite direction from the lower joint surface 211b, and a lower insulating layer 22b formed on the lower insulating surface 212b. The lower insulating layer 22b can be formed by being subjected to electrical insulation treatment and the lower conductive layer 21b can be formed by being subjected to anodized treatment.

The two upper conductive plates 30b are disposed at both sides of the upper conductive layer 11b of the upper mould 10b.

The two upper conductive wires 40b are connected to the upper conductive plates 30b and have a resistivity lower than the resistivity of the upper conductive layer 11b. Each of the upper conductive wires 40b is made of copper (or coated with silver or gold) and connected to a power supply 50b.

The two lower conductive plates 60b are disposed at both sides of the lower conductive layer 21b of the lower mould 20b.

The two lower conductive wires 70b are connected to the lower conductive plates 60b and have a resistivity lower than the resistivity of the lower conductive layer 21b. Each of the lower conductive wires 70b is made of copper (or coated with silver or gold) and connected to a power supply 50b.

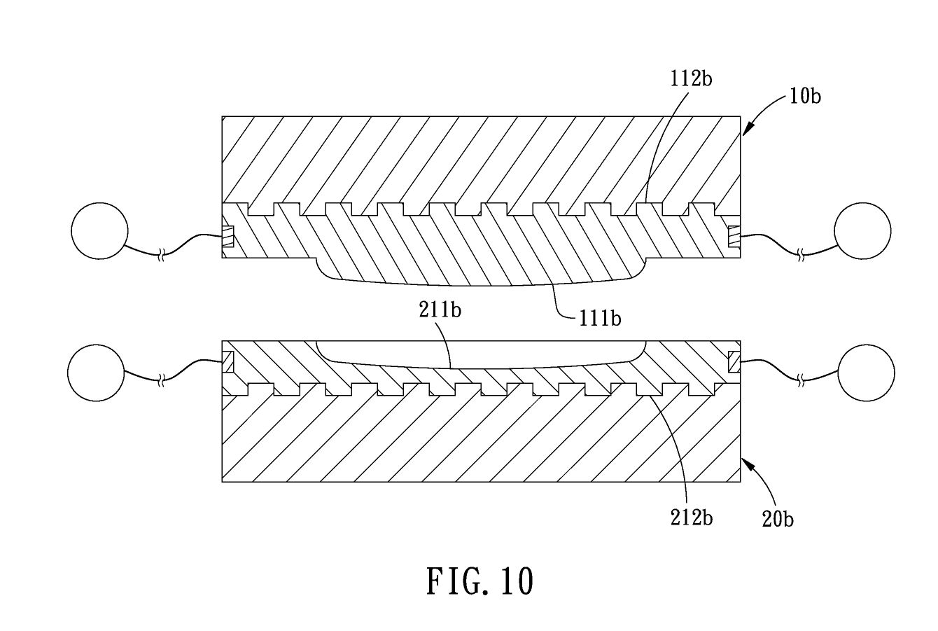

Referring then to FIG. 10, a heating device in accordance with one aspect of the third embodiment of the present invention is shown, which is also capable of reducing the time required to heat the upper and lower joint surface 111b, 211b from a room temperature to an operating temperature, namely, the upper insulating surface 112b of the upper mould 10b is also designed to be larger than the upper joint surface 111b in the same way as the first embodiment, and the lower insulating surface 212b of the lower mould 20b is also designed to be larger than the lower joint surface 211b in the same way as the first embodiment, so further description is omitted.

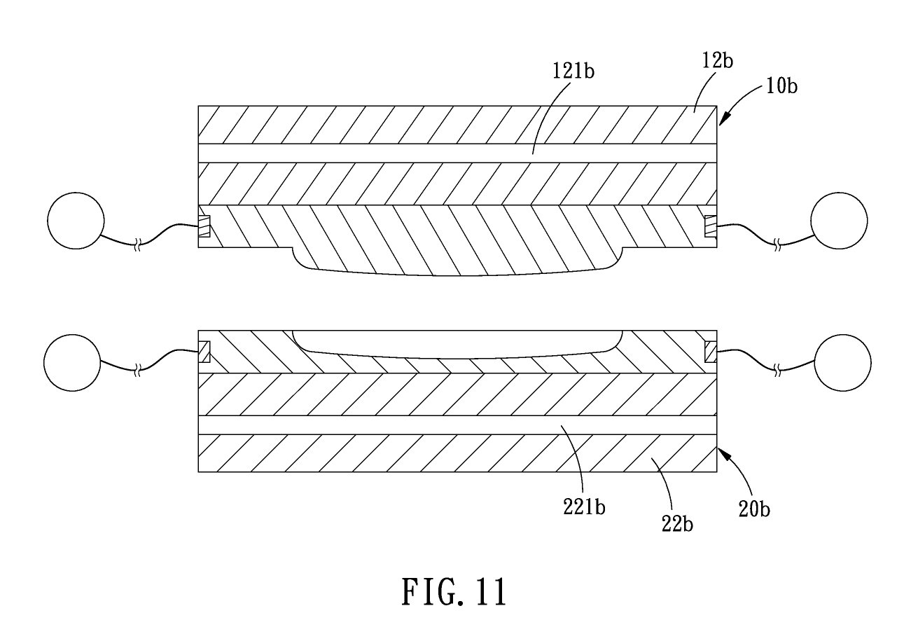

Referring to FIG. 11, a heating device in accordance with another aspect of the third embodiment of the present invention is shown, in the upper insulating layer 12b of the upper mould 10b is provided an upper cooling passage 121b which is filled with coolant, and in the lower insulating layer 22b of the lower mould 20b is also provided a lower cooling passage 221b which is filled with coolant so as to extend the service life of the mould assembly.

While we have shown and described various embodiments in accordance with the present invention, it is clear to those skilled in the art that further embodiments may be made without departing from the scope of the present invention.

What is claimed is:

1. A mould assembly with a heating device comprising:
an upper mould with an upper joint surface;
a lower mould including a conductive layer, a lower joint surface which is formed on the conductive layer and faces the upper joint surface, an insulating surface which is formed on the conductive layer and faces in an opposite direction from the lower joint surface, an insulating formed on the insulating surface;
two conductive plates disposed on the conductive layer of the lower mould; and
two conductive wires being connected to the conductive plates and each having a resistivity lower than a resistivity of the conductive layer.

2. The mould assembly with a heating device as claimed in claim 1, wherein the insulating surface of the lower mould is larger than the lower joint surface.

3. The mould assembly with a heating device as claimed in claim 1, wherein the conductive layer of the lower mould is made of steel or aluminum, and the conductive wires are made of copper or coated with silver or gold.

4. The mould assembly with a heating device as claimed in claim 1, wherein the insulating layer of the lower mould is provided with a cooling passage.

5. A mould assembly with a heating device comprising:
an upper mould including a conductive layer, an upper joint surface formed on the conductive layer, an insulating surface which is formed on the conductive layer and faces in an opposite direction from the upper joint surface, and an insulating layer formed on the insulating surface;
a lower mould with a lower joint surface facing the upper joint surface;
two conductive plates disposed on the conductive layer of the upper mould; and
two conductive wires being connected to the conductive plates and having a resistivity lower than a resistivity of the conductive layer.

6. The mould assembly with a heating device as claimed in claim 5, wherein the insulating surface of the upper mould is larger than the upper joint surface.

7. The mould assembly with a heating device as claimed in claim 5, wherein the conductive layer of the upper mould is made of steel or aluminum, and the conductive wires are made of copper or coated with silver or gold.

8. A mould assembly with a heating device comprising:
an upper mould including an upper conductive layer, an upper joint surface formed on the upper conductive layer, an upper insulating surface which is formed on the upper conductive layer and faces in an opposite direction from the upper joint surface, and an upper insulating layer formed on the upper insulating surface;
a lower mould including a lower conductive layer, a lower joint surface formed on the lower conductive layer, a lower insulating surface which is formed on the lower conductive layer and faces in an opposite direction from the lower joint surface, and a lower insulating layer formed on the lower insulating surface;
two upper conductive plates disposed on the upper conductive layer of the upper mould;
two upper conductive wires being connected to the upper conductive plates and having a resistivity lower than a resistivity of the upper conductive layer;
two lower conductive plates disposed on the lower conductive layer of the lower mould; and
two lower conductive wires connected to the lower conductive plates and having a resistivity lower than a resistivity of the lower conductive layer.

9. The mould assembly with a heating device as claimed in claim 8, wherein the upper insulating surface of the upper mould is larger than the upper joint surface, and the lower insulating surface of the lower mould is larger than the lower joint surface.

10. The mould assembly with a heating device as claimed in claim 8, wherein the upper conductive layer of the upper mould and the lower conductive layer of the lower mould are made of steel or aluminum, and the upper and lower conductive wires are made of copper or coated with silver or gold.
